(19) United States
(12) Patent Application Publication
(10) Pub. No.: US 2025/0299117 A1
(43) Pub. Date: Sep. 25, 2025

(54) ELECTRICAL ASSET USAGE MONITORING SYSTEM AND METHOD INCLUDING ALERT NOTIFICATIONS

(71) Applicant: POLYSENSE SOLUTIONS INC., Winnipeg (CA)

(72) Inventor: Matthew Daniel Brian Gale, Winnipeg (CA)

(21) Appl. No.: 18/614,003

(22) Filed: Mar. 22, 2024

(51) Int. Cl. G06Q 10/0631; G06Q 10/20; G06Q 50/06

(52) U.S. Cl. CPC G06Q 10/0631; G06Q 10/20; G06Q 50/06

(57) ABSTRACT

A monitoring system for electrical assets, for example industrial machines, includes monitoring devices measuring current and a controller arranged to communicate measured electrical characteristic values to a computer server which stores the values power values in a database record associated with each monitoring device. Each database record includes a time series of the electrical power values and irregular usage criteria indicative of an irregular usage of the asset to generate alerts as required. The server can also generate various reports including (i) graphically representing s the power values relative to active and idle thresholds to determine if the asset is active, idle or off; (ii) a heat map representing usage based on the power values; and (iii) a dashboard view showing the real time active or inactive status of each asset based on the power values.

### FIELD OF THE INVENTION

The present invention relates to a monitoring system to monitor usage of electrical assets, for example electrical appliances and industrial machines in an industrial setting, based on electrical power consumption, and more particularly the present invention relates to an electrical asset usage monitoring system which stores monitored electrical usage data in viewable database record and compares the usage data to alert criteria for notifying an operator of irregular usage.

### BACKGROUND

In a laboratory or industrial setting with many pieces of machinery or equipment, generally referred to as assets, owners or managers of these assets do not know how often or when these assets are actually utilized to perform work. The owners or managers resort to anecdotal evidence from users of the assets as to how often the equipment is used. The owners or managers also do not want to keep track manually when the equipment is used, and thus need an automatic solution.

These same owners or managers also resort to reactive maintenance as opposed to proactive maintenance for the above said assets. Most assets slowly and silently degrade until a failure occurs, if stringent maintenance policies aren't followed. A universal automatic way of detecting early asset degradation is needed in order to contribute to a robust proactive maintenance system.

Furthermore, with regard to electrical assets such as refrigerated storage units, refrigeration compressors are used to regulate the temperature of storage units. Over time, these compressors may experience wear and tear, which can lead to decreased performance and decreased efficiency. In order to maintain the performance and efficiency of the refrigeration compressor, it is important to periodically perform maintenance and/or replace the compressor when necessary. Unfortunately, this is difficult to predict or measure, and most owners of this equipment end up experiencing equipment failure instead of proactively dealing with the problem before failure.

### SUMMARY OF THE INVENTION

The present invention seeks to address some of the problems associated with the prior art by monitor the electrical characteristics and values that the electrical asset is using. By measuring, reporting, analyzing, and displaying the amperage, voltage, frequency, and/or power factor that an asset is consuming, it can be determined if the asset is currently performing work (being utilized) or not. This information is then processed by algorithms on a cloud application to graphically and quantitatively show clients how often and when their assets are utilized. Using heatmaps, fuel gages, pie charts, bar charts, line charts, and other graphics and numerical outputs, clients can quickly and effectively obtain the data they need to make more effective, intelligent, data driven decisions.

Using the same information (amperage, voltage, frequency, and/or power factor) it is possible to detect if an asset may require maintenance or human assistance by analyzing the current and historical data to determine if the asset appears to be using more/less power than normal, if the phases are out of sync, if there are any issues with the power factor, or any other irregularities are present in the operation of the assets.

In some embodiments, a sensor is provided for detecting the duty cycle of a refrigeration compressor, which can be used to determine when the refrigeration compressor may be in need of maintenance or replacement. The sensor can include a non-invasive current (amperage) sensor and control system that can detect when the refrigeration compressor is on vs off. The control system is capable of analyzing the duty cycle data and providing an indication when the duty cycle exceeds a predetermined threshold, indicating that the refrigeration compressor may be in need of maintenance or replacement. The sensing device of the present invention can be integrated into the refrigeration compressor, or can be placed in close proximity to the refrigeration compressor. The control system of the present invention is capable of analyzing the duty cycle data and providing an indication when the duty cycle exceeds a predetermined threshold. The indication can be provided in a variety of forms, such as an auditory alarm, visual alarm, or message displayed on software on any internet connected device.

Accordingly, the present invention provides a sensor for detecting the duty cycle of a refrigeration compressor, which can be used to determine when the refrigeration compressor may be in need of maintenance or replacement. The sensor or monitoring device includes a sensing device and a control system, which work together to provide an indication when the duty cycle exceeds a predetermined threshold. This information can be used by maintenance personnel to perform necessary maintenance or replace the refrigeration compressor when necessary, ensuring that the performance and efficiency of the refrigeration compressor is maintained.

According to one aspect of the present invention there is provided a monitoring system for monitoring a plurality of electrical assets which consume electricity, the system comprising:
a computer server;
a plurality of monitoring devices arranged to be associated with the electrical assets respectively, each monitoring device including (i) an electrical sensor arranged to be operatively associated with the respective electrical asset so as to be arranged to measure an electrical characteristic value related to electrical consumption by the electrical asset, and (ii) a controller arranged to communicate the electrical characteristic values to the computer server periodically over time;
the computer server including a memory storing programming instructions thereon and a processor arranged to execute the programming instructions whereby the computer server is arranged to:
   (i) store the electrical characteristic values from the monitoring devices as electrical power values representing electrical power consumed by the electrical asset in a database comprising a database record associated with each monitoring device, in which each database record comprises (a) a time series of the electrical power values representing the electrical power consumed by the electrical asset over time, and (b) irregular usage criteria indicative of an irregular usage of the electrical assets;
   (ii) compare the electrical power values to the irregular usage criteria stored on the computer server; and
   (iii) generate a notification if the irregular usage criteria is met.

The electrical sensor of the monitoring devices may be a current sensor in which the measured electrical characteristic value is representative of electrical current, wherein the computer server is arranged to convert the measured electrical characteristic values received from the monitoring devices to the power values using prescribed voltage ratings associated with the respective electrical assets and stored on the computer server.

Preferably the irregular usage criteria is individually configurable for each electrical asset. The irregular usage criteria may include (i) the electrical asset changing status from an active use state to an inactive state; (ii) an upper threshold associated with each electrical asset such that a notification is generated if the electrical power values for one electrical asset exceeds the respective upper threshold for that electrical asset, (iii) a lower threshold associated with each electrical asset such that a notification is generated if the electrical power values for one electrical asset falls below the respective lower threshold for that electrical asset, and/or (iv) a scheduled time range associated with one of the electrical assets such that a notification is generated if that electrical asset is determined to be in an active state based on the power values at a time that is outside of the scheduled time range.

When one of the electrical assets is a cyclically operated asset which operates according to an operating cycle, the irregular usage criteria associated with the cyclically operated asset may include at least one duty cycle criterium related to the operating cycle of the electrical asset. The at least one duty cycle criterium may include (i) a cycle duration threshold such that a notification is generated if the combined active and inactive portions of the cycle exceed the cycle duration threshold, (ii) an active cycle duration threshold such that a notification is generated if an active portion of the operating cycle exceeds the active cycle duration threshold, (iii) an inactive cycle duration threshold such that a notification is generated if an inactive portion of the operating cycle exceeds the inactive cycle duration threshold, and/or (iv) a duty cycle threshold range such that a notification is generated if an active portion of the operating cycle as a percentage of available time falls outside of the duty cycle threshold range.

The computer server may be further arranged to generate a report for at least one selected database record over a selected time range which graphically represents the electrical power values over the selected time range for said at least one selected database record in a manner which visually distinguishes the electrical power values between an active use state above an active use threshold, an idle use state between the active use threshold and an idle threshold, and an inactive state below the idle threshold.

The computer server may be further arranged to generate a report for at least one selected database record over a selected time range comprising one or more weeks in duration, the report comprising a heat map representing the electrical power values associated with said at least one selected database record in which a first axis of the heat map represents time intervals, a second axis of the heat map represents days of the week, and each pixel visually represents a cumulative usage of the electrical asset associated with said at least one database record for a corresponding time and a corresponding day of the week for said one or more weeks.

In this instance, the heat map may be representative of one database record associated with one electrical asset, in which the pixels of the heat map visually distinguish between (i) an active use state and (ii) an inactive state or an idle state of the electrical asset.

Alternatively, the pixels of the heat map may be indicative of cumulative electrical power consumption of said at least one database record based on the electrical power values. The at least one database record in this instance, may include all of the database records, so that the heat map is a cumulative representation of all database records associated with all electrical assets.

The computer server may be further arranged to: (i) compare the electrical power values to an active state threshold in real time to determine if the electrical asset for each monitoring device is in an active state or an inactive state; and (ii) generate a report in real time comprising a dashboard view in which each electrical asset is graphically represented together with the determined active state or inactive state associated with that electrical asset.

According to a second aspect of the present invention there is provided a monitoring system for monitoring a plurality of electrical assets which consume electricity, the system comprising:
a computer server;
a plurality of monitoring devices arranged to be associated with the electrical assets respectively, each monitoring device including (i) an electrical sensor arranged to be operatively associated with the respective electrical asset so as to be arranged to measure an electrical characteristic value related to electrical consumption by the electrical asset, and (ii) a controller arranged to communicate the electrical characteristic values to the computer server periodically over time;
the computer server including a memory storing programming instructions thereon and a processor arranged to execute the programming instructions whereby the computer server is arranged to:
   (i) store the electrical characteristic values from the monitoring devices as electrical power values representing electrical power consumed by the electrical asset in a database comprising a database record associated with each monitoring device, in which each database record comprises a time series of the electrical power values representing the electrical power consumed by the electrical asset over time; and
   (ii) to generate a report for at least one selected database record over a selected time range which graphically represents the electrical power values over the selected time range for said at least one selected database record in a manner which visually distinguishes the electrical power values between an active use state above an active use threshold, an idle use state between the active use threshold and an idle threshold, and an inactive state below the idle threshold.

According to a further aspect of the present invention there is provided a monitoring system for monitoring a plurality of electrical assets which consume electricity, the system comprising:
a computer server;
a plurality of monitoring devices arranged to be associated with the electrical assets respectively, each monitoring device including (i) an electrical sensor arranged to be operatively associated with the respective electrical asset so as to be arranged to measure an electrical characteristic value related to electrical consumption by the electrical asset, and (ii) a controller arranged to communicate the electrical characteristic values to the computer server periodically over time;
the computer server including a memory storing programming instructions thereon and a processor arranged to execute the programming instructions whereby the computer server is arranged to:
   (i) store the electrical characteristic values from the monitoring devices as electrical power values representing electrical power consumed by the electrical asset in a database comprising a database record associated with each monitoring device, in which each database record comprises a time series of the electrical power values representing the electrical power consumed by the electrical asset over time; and
   (ii) generate a report for at least one selected database record over a selected time range comprising one or more weeks in duration, the report comprising a heat map representing the electrical power values associated with said at least one selected database record in which a first axis of the heat map represents time intervals, a second axis of the heat map represents days of the week, and each pixel visually represents a cumulative usage of the electrical asset associated with said at least one database record for a corresponding time and a corresponding day of the week for said one or more weeks.

### BRIEF DESCRIPTION OF THE DRAWINGS

Some embodiments of the invention will now be described in conjunction with the accompanying drawings in which:

FIG. 1 is a schematic representation of the monitoring system for use in monitoring a plurality of electrical assets;

FIG. 2 is a schematic representation of one of the monitoring devices of the monitoring system of FIG. 1 for non-invasive monitoring of some of the electrical assets;

FIG. 3 is a schematic representation of an alternative monitoring device of the monitoring system of FIG. 1 for wired monitoring of some of the electrical assets;

FIG. 4 is a sample dashboard display viewed on a user computer device for viewing a summary of all database records of one client's dataset;

FIG. 5 is a sample database record display viewed on the user computer device for a detailed viewing of the database record associated with one electrical asset being monitored by one monitoring device;

FIG. 6 is an enlarged portion of the database record display of FIG. 5 in which power consumption of the associated electrical asset is graphically represented over time relative to threshold lines that distinguish between active use state and an idle state;

FIG. 7 is a graphical display viewed on the user computer device for viewing utilisation of one electrical asset in hours relative to available and relative to a target usage.

FIG. 8 is a sample dashboard display viewed on the user computer device for viewing usage data for two database records associated with two electrical assets respectively, in which the usage data is presented as individual heat map associated with each electrical asset;

FIG. 9 is a sample dashboard display viewed on the user computer device for viewing the usage data for all electrical assets associated with one client, in which the usage data is presented as a cumulative heat map representing all of the electrical assets; and

FIG. 10 is a flow chart representing the collection of data from the monitoring devices to the computer server;

FIG. 11 is a flow chart representing a user interaction with the computer server;

FIG. 12 is a flow chart representing various operations of the monitoring system of FIG. 1.

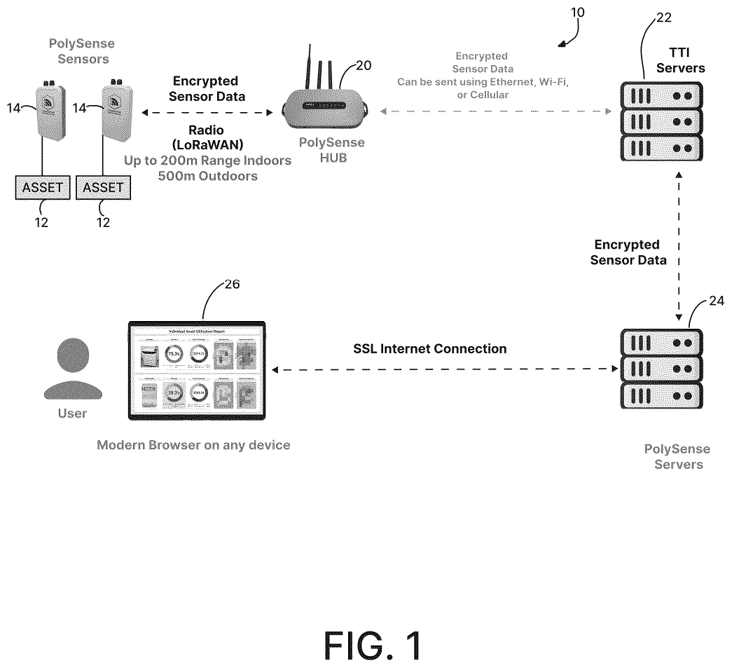

In the drawings like characters of reference indicate corresponding parts in the different figures.

### DETAILED DESCRIPTION

Referring to the accompanying figures, there is illustrated a monitoring system generally indicated by reference numeral 10. The monitoring system is intended for monitoring usage and electrical power consumption of a plurality of electrical assets 12, for example electrical appliances and industrial machines within an industrial setting. Typically, the electrical assets are of the type which can be in an inactive state in which the asset consumes substantially no power, an active use state in which the asset consumes a substantially amount of power while performing useful work, and an idle state in which the asset consumes a minimal amount of power to be ready to perform active work. In other instances, the electrical asset comprises a cyclically operated assets, for example a refrigeration compressor, in which the asset is regularly and periodically cycled between an active state and an inactive state at regular intervals according to a duty cycle. The duty cycle is defined herein as a percentage or portion of time that the electrical asset is active over the overall available time.

In a preferred arrangement of the system, the system includes a monitoring device 14 associated with each electrical asset 12 for monitoring that asset using one or more sensors 16. More particularly, the sensors of each monitoring device measure an electrical characteristic value related to electrical consumption by the electrical asset such as current, voltage, and/or power. Each monitoring device further includes an internal controller 18. The controller includes a processor and programming instructions stored on a memory for execution by the processor to execute the functions of the monitoring device including operating the sensors 16 and communicating the measured values from the sensors to other equipment as described in further detail herein.

In the illustrated embodiment, a plurality of the monitoring devices 14 communicate their respective measured and recorded values back to a computer server of the system through an intermediate hub 20 which may assist the individual controllers 18 of the monitoring devices 14 in providing some of their controller function. The hub 20 thus acts as an intermediate controller which assist in relaying data to the computer server for subsequent processing and analysis.

In the illustrated embodiment, the computer server includes a combination of (i) a local server 22 within the general environment of the monitoring devices 14 and the respective electrical assets 12, and (ii) a remote central server 24. Each of the local server 22 and the remote server 24 may comprise one or more computers at one location or at distributed locations to collectively provide the function of an overall computer server as described herein. Typically, at each client location locating a plurality of electrical assets 12, a local server is provided for recording all of the measured data from the monitoring devices 14 and for performing some degree of processing or analysis of the data for reporting to the client. A single central remote server 24 typically communicates with a plurality of different local client servers 22 at respective client locations to provide a common function to all of the local client servers in additional to recording data and processing data so that the data is accessible in the form of reports that can be accessed and viewed by clients on their own respective user computer devices 26. The remote server 24 communicates with the local servers 22 over a communications network such as the Internet. Likewise individual user computer devices 26, for example personal computers including laptops, tablets, smart phones and the like, communicate with the remote server 24 over a communications network such as the Internet. The user computer devices 26 can also communicate over a local area network with the local server 22 when being used at the client location.

The local servers 22 and the remote server 24 may have similar functions in communicating with the monitoring devices 14 directly or indirectly to acquire the measured data therefrom and store the data in a database including a database record associated with each electrical asset 12 in which the database records for all assets at one client location are organized in a respective client data set accessible by the client associated with that location.

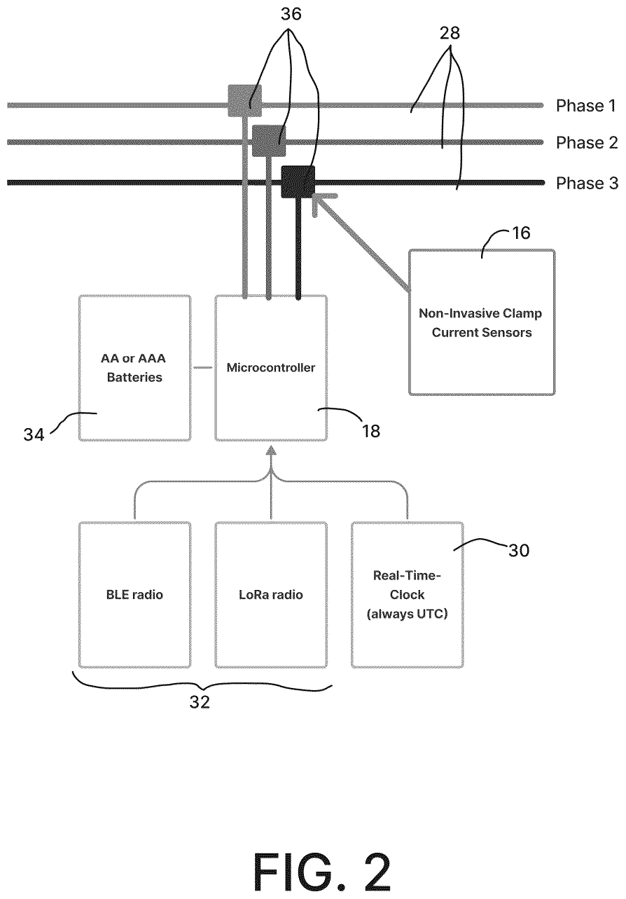

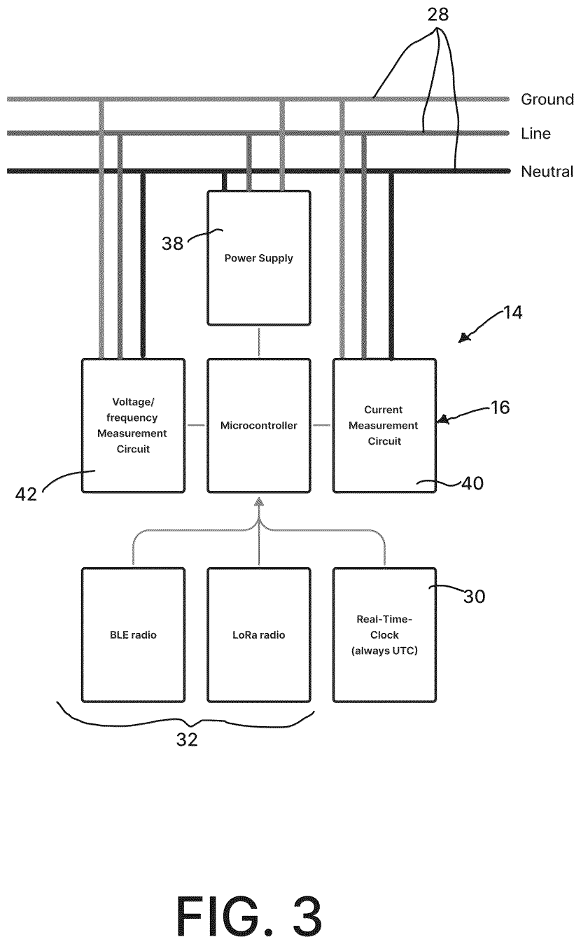

The monitoring devices 14 may take various forms for measuring various aspects related to electrical consumption by the electrical assets 12. According to a first embodiment in FIG. 2, the monitoring device measures electrical current values indicative of electrical current being consumed by the asset by being operatively connected in a non-invasive relationship with one or more conductors 28 providing electrical power to the asset 12. The monitoring device 14 in this instance is suited for use with single phase or three-phase conductors. According to a second embodiment in FIG. 3, the monitoring device 14 forms a direct wired connection with the conductors 28 supplying electrical power to the associated electrical asset 12.

In each instance, the monitoring device has a controller 18 in communication with a real time clock 30 for recording the time and date of each measurement and for recording durations between measurements. Each controller also communicates with one or more communications antennas 32 which serve to transmit data wirelessly to the computer server.

In the instance of FIG. 2, the monitoring device 14 includes a battery 34 for supplying power to the controller. The sensor in this instance comprises an annular clamping member 36 which is mounted to fully surround the conductor 28 being monitored. The sensor is a current transformer which is arranged to produce a current signal or value in response to the magnetic field generated about the conductor from the current passing through that conductor. The measured value is proportional to the current passing through the conductor and can be used for determining the actual current in the conductor. To optimally make use of battery power, the current sensor 16 takes a measurement to measure electrical characteristic value indicative of current in a periodic manner at a first interval representing a sampling interval for example in the order of 30 seconds. The controller collects these sampled electrical characteristic values and stores them together as a packet for transmission to the computer server. At a second interval greater than the first interval, for example in the order of 10 minutes, the monitoring device 14 will transmit a packet to the computer server as electrical characteristic values measured by the sensor. The server in this instance typically receives further input for example configuration input from the user through the user computer device 26 to define the nominal voltage rating of the associated asset measured by the monitoring device 14 as well as other relevant information such as the sensing range of the current sensor 16. From this gathered information, the computer server is arranged to calculate an electrical power value for each electrical characteristic value received from the monitoring device 14 in real time.

In the instance of FIG. 3, the monitoring device includes a power adapter 38 forming a wired connection to the conductors being monitored such that the monitoring device 14 derives its power directly from the conductor. The controller 18 in this instance includes a current measurement circuit 40 in wired connection with the conductors for measuring current in the conductors and a voltage and/or frequency measurement circuit 42 in wired connection with the conductors for measuring voltage of the conductors. In view of the additional electrical characteristic values in the form of both current and voltage that can be measured from the device according to FIG. 3, as well as the ready availability of electrical power from the wired connection, additional processing can be performed on an ongoing basis by the controller 18 of the monitoring device 14 to immediately calculate an electrical power value associated with each sampling measurement by the monitoring device 14 in real time. These calculated power values can then be transmitted to the computer server for further processing and analysis. The monitoring device 14 according to FIG. 3 can also collect numerous sampled electrical characteristic values into packets for bulk transmission to the computer server, for example at an interval of five minutes.

In each instance, the computer server receives all of the electrical characteristic values from the monitoring devices 14, either as raw values indicative of current or calculated power values, and stores all of the measured electrical characteristic data in the database. The database includes a database record associated with each monitoring device 14 which is in turn associated with an individual respective electrical asset 12 being monitored by that device. The computer stores the electrical characteristic values from the monitoring devices as electrical power values calculated either at the monitoring devices 14 or at the computer server in which the electrical power values represent electrical power consumed by the electrical asset. Each database record thus comprises a time series of the electrical power values representing the electrical power consumed by the electrical asset over time. Accordingly, the computer server receives and records the electrical characteristic values in the database such that each data record for each electrical asset 12 includes a measured value field in which all of the values recorded over time are stored as a time series of electrical characteristic values representative of the electrical consumption of the electrical asset varying over time.

Each database record also includes a field relating to the state of use of the corresponding electrical asset 12 as it varies over time. Each database record stores an active use threshold and an idle threshold thereon which are set by the user by providing input through the user computer device 26. The active use or on threshold represents a real-time value in watts consumed by the asset when the asset is considered active and turned on such that any wattage being consumed above the active use threshold results in the asset being determined to be in the active use state. The idle threshold represents a real-time value in watts consumed by the asset when the asset is considered idle such that it is turned on and consuming power but not doing any substantial work. Any wattage being consumed that is above the idle threshold and below the active use threshold results in the asset being determined to be in the idle state. Any real-time value in watts consumed by the asset below the idle threshold, or optionally below a separate off threshold results in the asset being determined to be in the off state. The computer server can be arranged to compare the electrical power values to the state of use thresholds in real time to record the state of the asset as a timeseries of determined states stored in the state of use field of the respective database record for the associated asset.

In the instance of an electrical asset operated in a cyclical manner such that the state of the asset cycles between an active state and an inactive state on an ongoing basis, the state of use field may be a binary value which determines that the asset is active if the wattage is above a cycle threshold or in active if the wattage is below the cycle threshold. In this instance, various additional statistical data can be recorded and stored in a duty cycle field of the database record associated with the asset. Statistical data that is calculated on an ongoing basis includes measuring the duration of each active portion of the cyclical operation of the asset, measuring the duration of each inactive portion of the cyclical operation of the asset, and calculating an ongoing duty cycle over a prescribed duration or prescribed number of cycles in which the duty cycle is defined as the percentage of time that the asset 12 is in the active portion over the combined active and inactive portions of the operation of the asset 12. The statistics can also be calculated in real time on an ongoing basis.

The database also stores various alert criteria which are customizable and programmably adjustable or configurable by the user so that different alert criteria can be stored in association with each different monitoring device 14. In each instance, the alert criteria relates to identification of an irregular usage of the asset, such as usage or lack of usage at an expected or unexpected time, or consumption of an unexpected amount of power, so as to be indicative of an aspect of the electrical asset 12 that requires user intervention or maintenance, and accordingly the alert criteria is otherwise referred to herein as irregular usage criteria. The irregular usage criteria is typically configured by the user through input provided through the user interface operating on the user computer device 26. The irregular usage criteria is uniquely defined for each electrical asset 12 within the respective database record associated with that asset.

The irregular usage criteria includes a critical high threshold in the form of a real-time value in watts used by the asset to be considered using a critically high level of power. This critically high or upper threshold associated with the asset results in a notification being generated if the electrical power values for that asset exceed the upper threshold. Another criterium stored for each asset in the respective database record includes a critical low threshold in the form of a real-time value in watts used by the asset to be considered using a critically low level of power. This critically low or lower threshold associated with the asset results in a notification being generated if the electrical power values for that asset fall below the lower threshold.

In some instances the irregular usage criteria for an asset that is intended to be always operational may simply be the occurrence of an inactive state such that a notification will be generated if the electrical asset changes status from active use state to inactive state at any time. In other instances, certain electrical assets are only intended to be used within a scheduled time range such as during a normal workday or on a weekday but not a weekend as examples. Accordingly if the computer server determines that an electrical asset is determined to be in an active state based on the power values being measured at a time that is outside of the permissible scheduled time range defined by the usage criteria, an alarm condition is determined and a notification is generated for communication to the operator.

When the electrical asset is a cyclically operated asset which operates according to an operating cycle between active and inactive states, then the irregular usage criteria in this instance may be a criterium relating to the duty cycle or general operating cycle of the electrical asset in some manner. In one instance, the criterium includes an active cycle duration threshold such that a notification is generated if the active portion of the operating cycle exceeds the active cycle duration threshold. More particularly, an alert condition is determined if the cyclical asset continues to operate and does not return to an inactive cycle as expected.

Likewise, the criterium may include an inactive cycle duration threshold such that a notification is generated if the inactive portion of the operating cycle exceeds the inactive cycle duration threshold. More particularly an alert condition is determined if the cyclical asset does not resume operating in an active cycle as expected following on the inactive cycle.

When the computer server further calculates an ongoing duty cycle in real time by calculating the percentage of the active portion of the operating cycle relative to the combined active and inactive portions of the operating cycle, or the active portion of the operating cycle as a percentage of overall available time, the calculated duty cycle can be further compared to a duty cycle threshold range. The acceptable duty cycle threshold range may be defined as any value below an upper limit, any value above a lower limit, or any value between upper and lower limits. If the calculated duty cycle is determined to be outside of the acceptable duty cycle threshold range, then an alert condition is determined and a notification is generated to the operator. In other instances, the duty cycle threshold may be defined as a duty cycle increase limit or a duty cycle decrease limit which defines if the duty cycle is considered to be outside of the acceptable duty cycle threshold range. For example, a percentage of increase in the duty cycle or a percentage of decrease in the duty cycle may determine an alert.

On a repeating and periodic basis, the computer server (which may include functions of the remote server 24, the local server 22, the intermediate controller 20, or portions of the individual controllers 18 of the monitoring devices 14) compares the measured values by the monitoring devices to the irregular usage criteria associated with the database record of the corresponding monitoring device 14 to determine if an alert condition exists for which the user or client should be notified. If an alert condition is determined as a result of the irregular usage criteria being met, the computer server will generate a notification transmitted to the user computer device 40 such as a text message, an email, or an audible or visual alarm of any kind that may be generated from an application or user interface running on the device 40 in response to the notification. In addition to notifying the operator of the alert condition, the notification would also identify the electrical asset 12 to which the alert condition is associated, and the type of threshold or irregular use criteria that was met so that the operator can diagnose how to rectify the error.

The user interface provided on the user device 40 for communication with the software on the computer servers also enables the user to input any data relating to (i) configuration of any thresholds or criteria which are customizable for any database record for the associated electrical asset 12, (ii) identification or configuration of any parameters associated with the electrical asset such as operating voltage of the asset, or any parameters of the monitoring device which may be required to convert the raw measured values from the monitoring devices representative of current to power values to be stored on the database, for use in generating reports or for comparison to the irregular usage criteria, (iii) identification of normal operating parameters relating to the duty cycle of the electrical asset in relation to cyclically operated electrical assets, (iv) parameters such as selected time ranges and the like which are used as inputs in generating reports for display to the user.

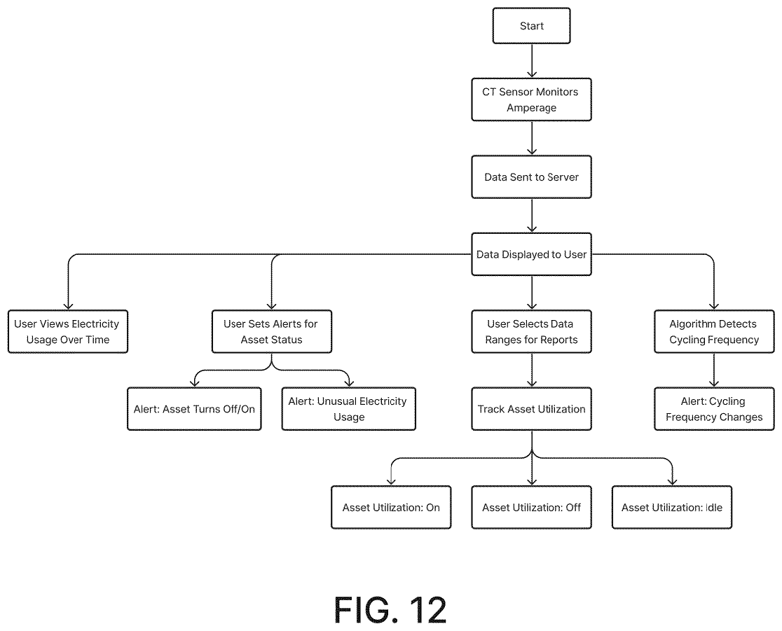

FIG. 12 describes general operation of the system 10 described herein. Initially, the monitoring devices 14 are activated to begin actively measuring and sampling electrical characteristic values from the conductors being monitored for the respective electrical assets 12. The electrical characteristic values are collected in packets by the controllers 18 of the monitoring devices and are in turn sent to the computer server through the intermediate controller 20 to the local server 22 and/or the remote server 24. The servers 22 and 24, collectively defined as the computer server of the system, organize the data in database records associated with the monitoring devices respectively as described above. Through a user computer device 26 an operator interacts with the computer server to store additional data associated with each asset within the respective database record including configuring custom alert criteria for each database record as well as setting various duty thresholds and the like.

The user can also enter various requests for generating various forms of reports based on the historical data recorded in the database records for each asset. Each report is typically based on a date range selected by the user so that the user can view electricity usage over time as well as generally track utilization by distinguishing between the assets being on, off or idle.

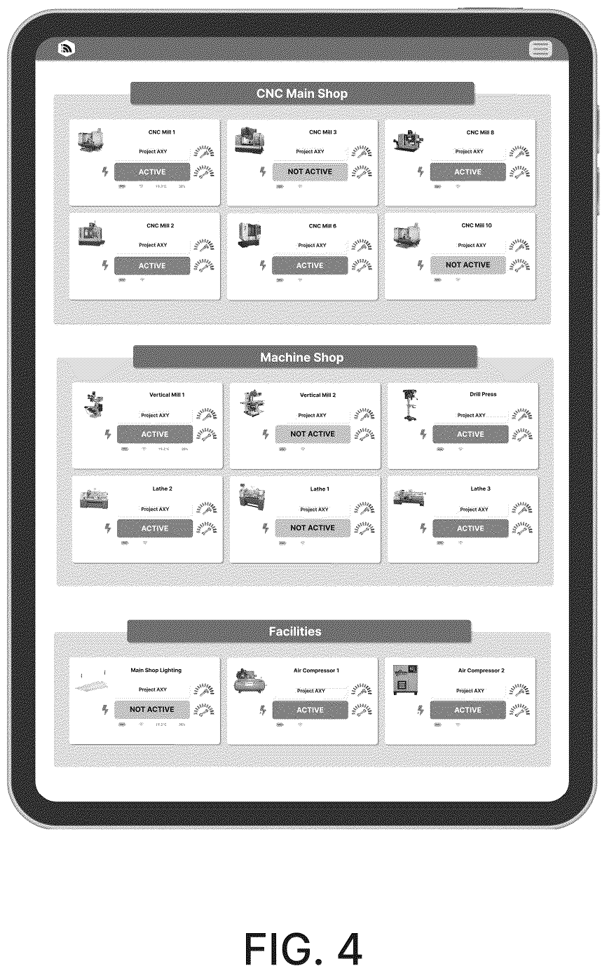

Turning now to FIG. 4, in a first sample report, the computer server, upon request from the user, generates an overall dashboard view of all assets associated with a single client location either on a single page view or a scrollable page. Each electrical asset 12 and the associated monitoring device 14 are represented by a respective tile including identifying information about the associated asset as well as displaying the currently determined state of use of the asset as described above. The report being based on real-time data from the database thus provides a real-time indication of the status of all assets.

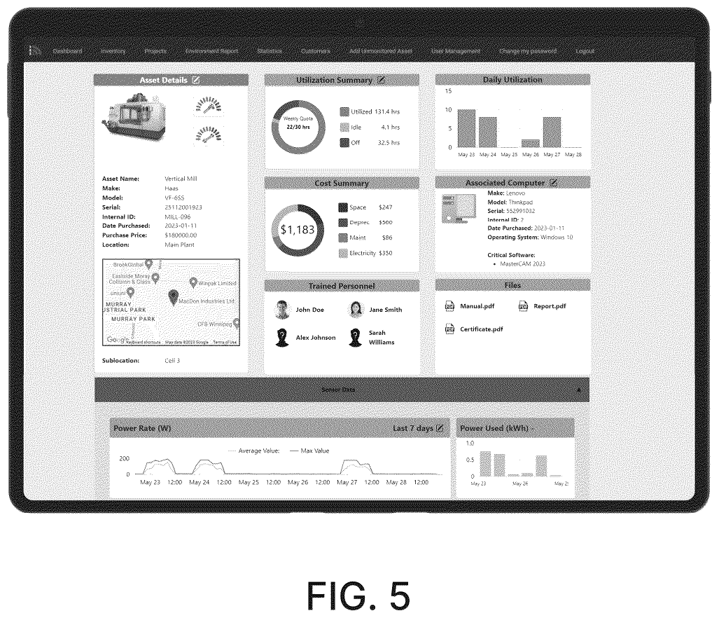

A further exemplary report displayed on the user device is shown in FIG. 5 in which the database record for one particular asset associated with one monitoring device 14 is illustrated in detail. The database record includes identifying information stored thereon with regard to the associated electrical asset 12 such as the identification of the asset, and the identification of various parameters associated with the asset. The same view can also illustrate a general summary of the utilization over the user selected time range such as a bar graph representing the amount of use each day or additional graphs illustrating the percentage of time that the asset is active in relative to overall available time.

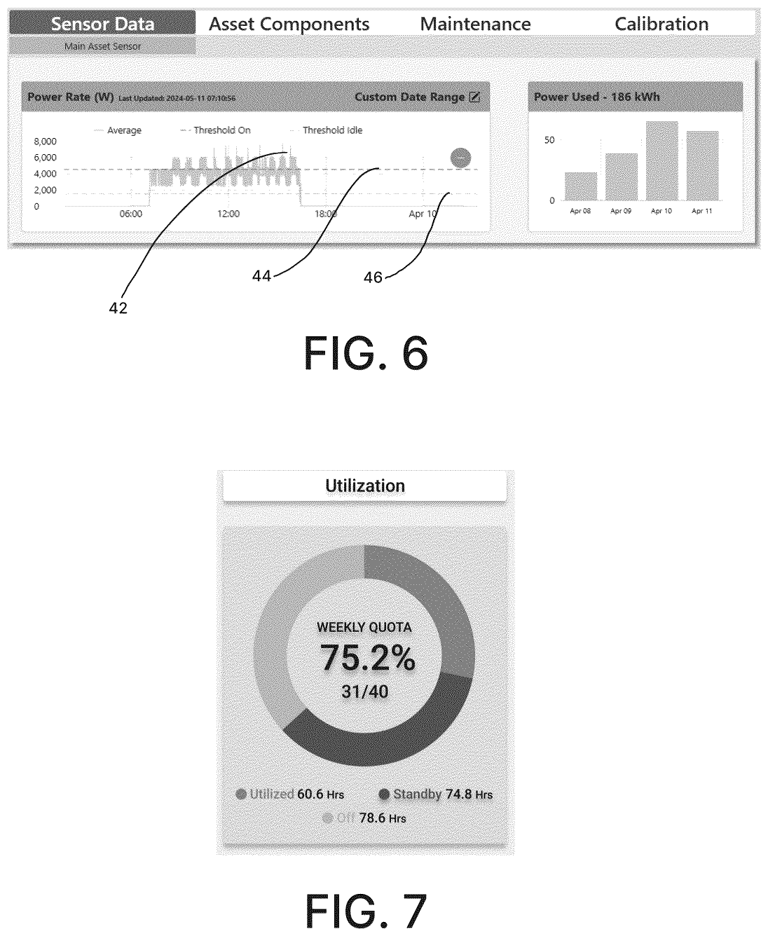

A graph illustrating the power consumption over the selected time can also be included in the detailed view of FIG. 5 as shown in greater detail in FIG. 6. In this instance a graph is shown in which a curve 42 represents power consumed over the selected time range together with a first line 44 on the graph representing the active use threshold and a second line 46 indicating the idle threshold. In this manner all portions of the power curve above the active use threshold visually distinguish the portions of the overall time range when the asset was in the active use state while portions of the power curve between the threshold lines visually distinguish the portions of the overall time range when the asset was in the idle state. Portions of the power curve below the idle threshold line illustrate when the asset was inactive.

The detailed view can also represent usage of a particular electrical asset by graphically representing the amount of time that an asset was in the active state compared to the combined active and inactive states. Also as shown in FIG. 7, the detailed view can illustrate the portion of time that the asset 12 was in the active state relative to a targeted amount of use or quota input by the user into the database record.

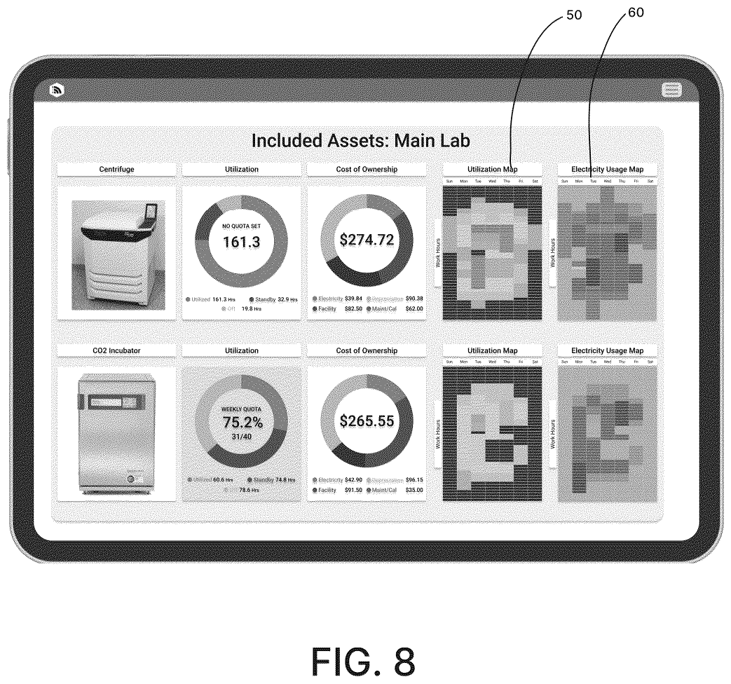

In another report based on the time series of power values stored in the database records of the database, a summary of utilization data can be provided for each asset by generating heat maps associated with the data of a single database record which in turn is associated with a single asset as shown in FIG. 8. For each asset in the corresponding database record, a heat map is generated in which a grid is defined having a horizontal axis representing day intervals and more particularly the seven days of the week and a vertical axis representing time of day intervals for example intervals of 15 or 30 minutes. Accordingly each pixel block within the heat map created represents one time interval for one day of the week for a set number of weeks based on the selected time range input by the user which may be one or more weeks. If the time range is one week, each pixel block represents the status for a single block of time. If the time range spans more than one week, each pixel block represents the status for the same block of time in each of the weeks added together as a cumulative representation of asset use.

Two forms of the heat map may be presented including a utilization map 50 and an electrical power usage map 60. In the instance of the utilization map, the data used for the heat map typically comprises a binary value representing either the asset being determined to be in the active use state, or alternatively in the idle or inactive state. In further arrangements, the inactive state and the idle state may be distinguished from one another so that three different states are used as input data for generating the heat map in which the idle state is at an intermediate location along the gradient between the active and inactive states. The values representing the active or inactive states are averaged together when the heat map represents multiple weeks of use and multiple values are associated with each pixel block at a given time of day and given day of the week. Various visual gradients may be used to visually distinguish between the different states such as a colour scale with different colours at opposing ends of the gradient, a greyscale that varies between black and white proportionally to the average values which vary between zero and one to designate the active and inactive states for example. Patterns may also be used to visually distinguish between the different values represented within each pixel block.

In the instance of an electrical power usage map, the data input into each pixel block is based on the power values of the associated database record. More particularly, the power values with the corresponding duration associated with each value is used to calculate kilowatt hours and the kilowatt hour values associated with each pixel block represent the cumulative kilowatt hours used by the asset for the given time of day and given day of the week associated with the pixel block over the number of weeks designated by the user as the basis for generating the report.

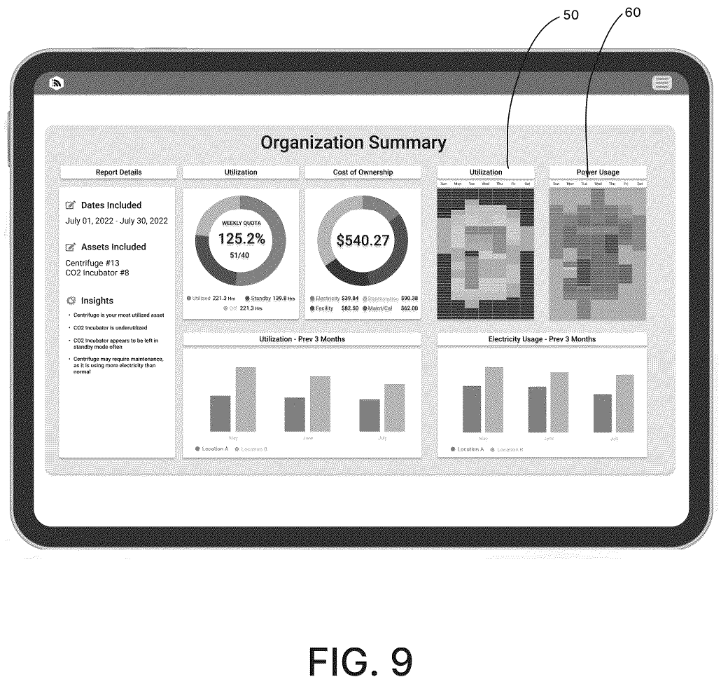

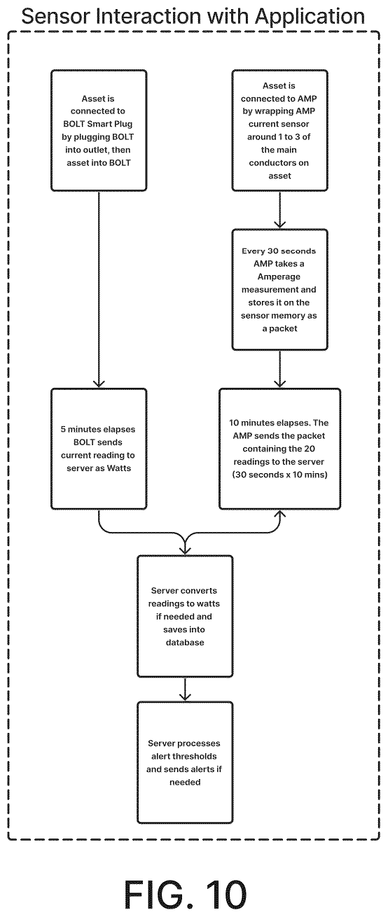

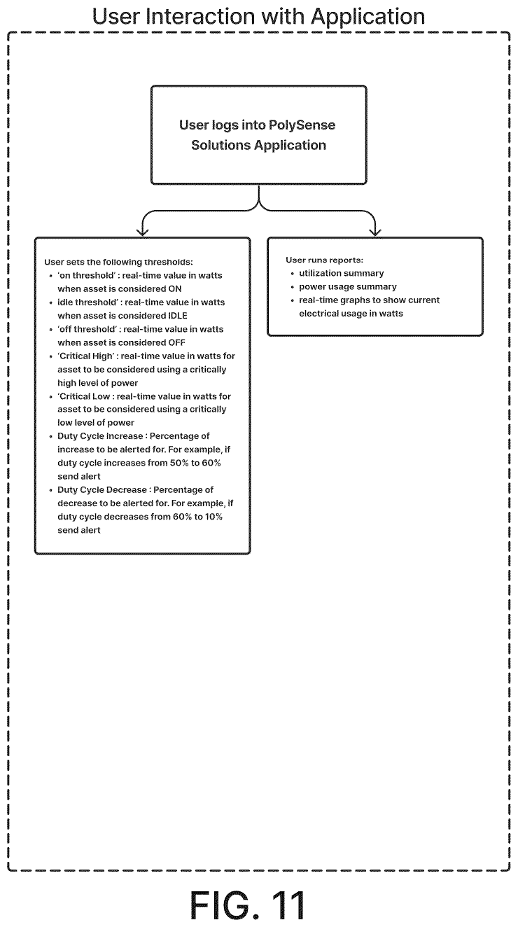

While the heat maps generated in FIG. 8 are associated with individual assets and rely on data from a single database record associated with a single asset, FIG. 9 illustrates another example report in which a heat map is generated that is representative of all assets or a designated group of assets associated with a particular client at a particular client location. The heat map may again take the form of a utilization map 50 or electrical power usage map 60; however, in this instance each pixel block represents an amalgamation of state of use values or the power values from all database records. That is each pixel block in the utilization map represents an average of the state of use value determined for all assets at the given time interval and given time of day associated with that pixel block. Similarly, each pixel block in the power usage map represents a cumulative total of the power values for all assets at the given time interval and given time of day associated with that pixel block.

As described herein, the main components of the invention include (i) the monitoring devices 14, as a plug-in style for standard assets with north American 120V (NEMA-5) receptacle, or a current transformer based style for non-invasively measuring current in a conductor, and (ii) software algorithms on the computer server that process the data and display to users.

For plug-in style monitoring devices 14 according to FIG. 3, the objective is to measure electrical characteristics of the asset that is plugged into the outlet and send these values to the server so that algorithms can analyze, store, and notify users when needed. In a typical laboratory, hospital, or manufacturing environment, assets are spread out from each other such that the usage of wireless communication protocols like Bluetooth, Zigbee or Wi-Fi posses many problems. Bluetooth and ZigBee cannot communicate long distances. Wi-Fi can communicate longer distances but still has dead zones in large facilities. Not only does Wi-Fi have dead zones, but it is an Information Technology professional's nightmare to have hundreds or even thousands of Wi-Fi connected devices that can be backdoors or vulnerabilities to their network infrastructure. Because of these reasons, this system 10 uses LoRa technology. LoRa (from “long range”) is a physical proprietary radio communication technique. It is based on spread spectrum modulation techniques derived from chirp spread spectrum (CSS) technology. It was developed by Cycleo (patent 9647718-B2), a company of Grenoble, France, later acquired by Semtech. This LoRa radio communication allows hundreds of our devices to communicate in a facility over long distances, with only one internet connected device, which is the head node or gateway. Many assets utilize the North American 120V NEMA-5 plug, which is the same plug on most household appliances. This monitoring device is installed between the receptacle and the facility outlet. This monitoring device 14 measures Voltage, Current, Power, Frequency, and Power Factor by using simple electronics principles and a microcontroller. Once the microcontroller measures and calculates these values, it creates a data packet containing the values then sends the packet to the LoRa gateway using a LoRa radio module. The gateway is simply an internet connected device that forwards the data packet to the server(s).

The non-invasive type monitoring device 14 of FIG. 2 has the same objectives, with the exception that it monitors multiple phases, and calculates if these phases are out of sync in order to predict if the asset will have failures, or is experiencing the beginning of a failure. In this instance, the monitoring device is installed in or near the electrical panel or where the conductors are separated and available to measure independently. Amperage is measured and these values are then transmitted over LoRa to the gateway so that the values can be processed on the server. The monitoring device 14 in the preferred arrangement of FIG. 2 is a current transformer used to sense the amount of current flowing through wire so that this information can be used to calculate the wattage of the asset if the nominal voltage of the asset is known. The current transformer or current sensor 16 is a type of sensor that clamps around one of the main powerlines or conductors supplying alternating current electricity to the asset. It operates non-invasively, meaning it does not require direct electrical connection to the conductor. The transformer measures the magnetic field around the conductor, which is directly proportional to the current flowing through it. The current transformer 16 outputs a secondary current which is a scaled-down safe to handle version of the primary current flowing through the conductor. The secondary current is then fed into the controller 18. The controller interprets this current to determine if and how much the asset is being utilized. The user decides which threshold will determine if the asset is on, idle, or off. For single phase electrical systems, wattage can be calculated simply by multiplying the current measured by the current transformer 16 with the nominal voltage of the asset. For three-phase systems, the calculation is more complex. A specific formula is used to account for the differences in a three-phase system. This formula translates the current measured on one of the phases into the total wattage used by the asset.

Data from the monitoring devices 14 is first transmitted over LoRaWAN to a third-party service called ‘The Things Stack’. The Things Stack utilizes a webhook that converts the LoRaWAN packet into JSON, then uses a HTTPS POST request to send this JSON formatted data to the remote server. This POST request is authenticated with an authorization token that is generated by the Token System, on the remote server. When the remote server receives this POST request, it will run through the invention algorithm.

Users can use a configuration tool to teach the algorithm if their asset is on or off. For example, the configuration tool will collect data on the asset for at least one cycle of performing work and sitting in an idle state. The configuration tool will then show the user a graph of the power used (y-axis) over time (x-axis), along with threshold lines where the configuration tool thinks the asset is performing work, and when it thinks it is not (on or off). If the configuration tool is correct, the user can accept, or adjust the thresholds accordingly. Once this process is complete, the software now knows when the asset is being utilized, and when it is not. (On, off, Idle)

The system is capable of generating a large variety of reports. The utilization report will calculate with our algorithms and display to the user. Reports allow data to be displayed regarding utilization of the asset including: How often is the asset in the ‘on’ state compared against the user's ideal utilization for this asset, How often asset sits idle, How much time is spent on maintenance and calibration, Cost of electricity for this asset, Cost of facility space for this asset, Cost of maintenance and calibration for this asset, and Cost of depreciation for this asset. Other reports that can be generated include a heat map diagram showing the frequency of utilization over days of the week, and a heat map diagram showing the electrical usage over days of the week.

When used with assets operating cyclically, additional criteria can be monitored. This includes detecting an increase in duty cycle on assets being monitored with the monitoring devices 14. If the duty cycle is increasing, it is typically cause for concern as the asset most likely needs preventative maintenance. The user can get alerts if the duty cycle increases by a user determined percentage. If the algorithms measure an increase in duty cycle, the user is alerted. This is most important with freezer and refrigeration compressors that cycle on and off to keep the internal temperatures low. If this compressor is cycling more often than normal, it is likely showing early signs of failure that can be prevented by intervening with maintenance. The user can also decide if they want text message and email alerts if the sensor does not observe the compressor cycling for a certain period of time which would indicate that the compressor has failed and temperatures will begin to rise soon inside the freezer/refrigerator.

Since various modifications can be made in the invention as herein above described, and many apparently widely different embodiments of same made, it is intended that all matter contained in the accompanying specification shall be interpreted as illustrative only and not in a limiting sense.

1. A monitoring system for monitoring a plurality of electrical assets which consume electricity, the system comprising:
a computer server;
a plurality of monitoring devices arranged to be associated with the electrical assets respectively, each monitoring device including (i) an electrical sensor arranged to be operatively associated with the respective electrical asset so as to be arranged to measure an electrical characteristic value related to electrical consumption by the electrical asset, and (ii) a controller arranged to communicate the electrical characteristic values to the computer server periodically over time;
the computer server including a memory storing programming instructions thereon and a processor arranged to execute the programming instructions whereby the computer server is arranged to:
(i) store the electrical characteristic values from the monitoring devices as electrical power values representing electrical power consumed by the electrical asset in a database comprising a database record associated with each monitoring device, in which each database record comprises (a) a time series of the electrical power values representing the electrical power consumed by the electrical asset over time, and (b) irregular usage criteria indicative of an irregular usage of the electrical assets;
(ii) compare the electrical power values to the irregular usage criteria stored on the computer server; and
(iii) generate a notification if the irregular usage criteria is met.

2. The system according to claim 1 wherein the electrical sensor of the monitoring devices is a current sensor in which the measured electrical characteristic value is representative of electrical current, and wherein the computer server is arranged to convert the measured electrical characteristic values received from the monitoring devices to the power values using prescribed voltage ratings associated with the respective electrical assets and stored on the computer server.

3. The system according to claim 1 the irregular usage criteria is individually configurable for each electrical asset.

4. The system according to claim 1 wherein the irregular usage criteria include the electrical asset changing status from an active use state to an inactive state.

5. The system according to claim 1 wherein the irregular usage criteria include an upper threshold associated with each electrical asset such that a notification is generated if the electrical power values for one electrical asset exceeds the respective upper threshold for that electrical asset.

6. The system according to claim 1 wherein the irregular usage criteria include a lower threshold associated with each electrical asset such that a notification is generated if the electrical power values for one electrical asset falls below the respective lower threshold for that electrical asset.

7. The system according to claim 1 wherein the irregular usage criteria include a scheduled time range associated with one of the electrical assets such that a notification is generated if that electrical asset is determined to be in an active state based on the power values at a time that is outside of the scheduled time range.

8. The system according to claim 1 wherein one of the electrical assets is a cyclically operated asset which operates according to an operating cycle and wherein the irregular usage criteria associated with the cyclically operated asset include at least one duty cycle criterium related to the operating cycle of the electrical asset.

9. The system according to claim 8 wherein the at least one duty cycle criterium includes a cycle duration threshold such that a notification is generated if the combined active and inactive portions of the cycle exceed the cycle duration threshold.

10. The system according to claim 8 wherein the at least one duty cycle criterium includes an active cycle duration threshold such that a notification is generated if an active portion of the operating cycle exceeds the active cycle duration threshold.

11. The system according to claim 8 wherein the at least one duty cycle criterium includes an inactive cycle duration threshold such that a notification is generated if an inactive portion of the operating cycle exceeds the inactive cycle duration threshold.

12. The system according to claim 8 wherein the at least one duty cycle criterium includes a duty cycle threshold range such that a notification is generated if an active portion of the operating cycle as a percentage of available time falls outside of the duty cycle threshold range.

13. The system according to claim 1 wherein the computer server is further arranged to generate a report for at least one selected database record over a selected time range which graphically represents the electrical power values over the selected time range for said at least one selected database record in a manner which visually distinguishes the electrical power values between an active use state above an active use threshold, an idle use state between the active use threshold and an idle threshold, and an inactive state below the idle threshold.

14. The system according to claim 1 wherein the computer server is further arranged to generate a report for at least one selected database record over a selected time range comprising one or more weeks in duration, the report comprising a heat map representing the electrical power values associated with said at least one selected database record in which a first axis of the heat map represents time intervals, a second axis of the heat map represents days of the week, and each pixel visually represents a cumulative usage of the electrical asset associated with said at least one database record for a corresponding time and a corresponding day of the week for said one or more weeks.

15. The system according to claim 14 wherein the heat map is representative of one database record associated with one electrical asset, and wherein the pixels of the heat map visually distinguish between (i) an active use state and (ii) an inactive state or an idle state of the electrical asset.

16. The system according to claim 14 wherein the pixels of the heat map are indicative of cumulative electrical power consumption of said at least one database record based on the electrical power values.

17. The system according to claim 14 wherein said at least one database record comprises all of the database records, and wherein the heat map is a cumulative representation of all database records associated with all electrical assets.

18. The system according to claim 1 wherein the computer server is further arranged to:
compare the electrical power values to an active state threshold in real time to determine if the electrical asset for each monitoring device is in an active state or an inactive state;
generate a report in real time comprising a dashboard view in which each electrical asset is graphically represented together with the determined active state or inactive state associated with that electrical asset.

19. A monitoring system for monitoring a plurality of electrical assets which consume electricity, the system comprising:
a computer server;
a plurality of monitoring devices arranged to be associated with the electrical assets respectively, each monitoring device including (i) an electrical sensor arranged to be operatively associated with the respective electrical asset so as to be arranged to measure an electrical characteristic value related to electrical consumption by the electrical asset, and (ii) a controller arranged to communicate the electrical characteristic values to the computer server periodically over time;
the computer server including a memory storing programming instructions thereon and a processor arranged to execute the programming instructions whereby the computer server is arranged to:
(i) store the electrical characteristic values from the monitoring devices as electrical power values representing electrical power consumed by the electrical asset in a database comprising a database record associated with each monitoring device, in which each database record comprises a time series of the electrical power values representing the electrical power consumed by the electrical asset over time; and
(ii) to generate a report for at least one selected database record over a selected time range which graphically represents the electrical power values over the selected time range for said at least one selected database record in a manner which visually distinguishes the electrical power values between an active use state above an active use threshold, an idle use state between the active use threshold and an idle threshold, and an inactive state below the idle threshold.

20. A monitoring system for monitoring a plurality of electrical assets which consume electricity, the system comprising:
a computer server;
a plurality of monitoring devices arranged to be associated with the electrical assets respectively, each monitoring device including (i) an electrical sensor arranged to be operatively associated with the respective electrical asset so as to be arranged to measure an electrical characteristic value related to electrical consumption by the electrical asset, and (ii) a controller arranged to communicate the electrical characteristic values to the computer server periodically over time;
the computer server including a memory storing programming instructions thereon and a processor arranged to execute the programming instructions whereby the computer server is arranged to:
(i) store the electrical characteristic values from the monitoring devices as electrical power values representing electrical power consumed by the electrical asset in a database comprising a database record associated with each monitoring device, in which each database record comprises a time series of the electrical power values representing the electrical power consumed by the electrical asset over time; and
(ii) generate a report for at least one selected database record over a selected time range comprising one or more weeks in duration, the report comprising a heat map representing the electrical characteristic values associated with said at least one selected database record in which a first axis of the heat map represents time intervals, a second axis of the heat map represents days of the week, and each pixel visually represents a cumulative usage of the electrical asset associated with said at least one database record for a corresponding time and a corresponding day of the week for said one or more weeks.
